(19) United States
(12) Patent Application Publication
(10) Pub. No.: US 2005/0053695 A1
(43) Pub. Date: Mar. 10, 2005

(54) Reducing bar hardness via repositioning of micronutrients within a matrix

(75) Inventors: Edward Charles Coleman, New Fairfield, CT (US); Ahmad Akashe, Mundelein, IL (US); Michael Tancredi, Sparta, NJ (US); Brenda Kay Smith, Mahwah, NJ (US)

Correspondence Address: FITCH EVEN TABIN AND FLANNERY, 120 SOUTH LA SALLE STREET, SUITE 1600, CHICAGO, IL, 60603-3406, US

(73) Assignee: Kraft Foods Holdings, Inc.

(21) Appl. No.: 10/840,750

(22) Filed: May 6, 2004

Related U.S. Application Data
(63) Continuation-in-part of application No. 10/655,250, filed on Sep. 4, 2003.

(51) Int. Cl. C05C 9/00

(52) U.S. Cl. 426/72

(57) ABSTRACT

Described herein are methods and compositions for repositioning micronutrients, especially calcium, in a food product, such as a nutritional bar, to minimize hardness and extend shelf-life. The methods and compositions of the present invention include applying a layer of a micronutrient, especially calcium, fortified matrix to a food bar core. The matrix is a low moisture confectionary layer or coating, preferably a chocolate or caramel layer or coating having calcium, or other micronutrient, solubilized therein. The resultant food product advantageously contains a substantial amount of essential micronutrients without adversely effecting organolpetic qualities such as texture.

### RELATED APPLICATION

The present application is a continuation-in-part of U.S. patent application Ser. No. 10/655,250, filed Sep. 9, 2003, which is hereby incorporated by reference.

### FIELD OF THE INVENTION

The present invention generally relates to food compositions, and more particularly to confectionary type products such as nutritional bars. More specifically, this invention relates to methods and compositions for repositioning micronutrients (especially calcium and magnesium) in such food products to minimize hardness and extend shelf-life.

### DESCRIPTION OF THE PRIOR ART

Various types of nutritional food bars have been previously described. Nutritional bars come in numerous flavors with variable nutrient components. Most nutritional bars, however, contain a balance of proteins, fats, carbohydrates, vitamins, and minerals. Humans, consume proteins, fats, and carbohydrates for energy to maintain vital bodily functions. Proteins, fats, and carbohydrates may be converted into glucose which is used to provide energy together with a feeling of satiety. Protein and fat are more slowly converted to energy than carbohydrates. As such, a meal consisting only of protein and/or fat converts so slowly to energy that there is no notable rise in blood glucose level. Alternatively, a meal consisting of pure carbohydrates converts rapidly to energy causing a sharp, unsustainable peak in blood glucose level. Therefore, balancing fat, carbohydrate, and protein content in a meal is necessary to stabilize and prolong an elevated blood glucose level for providing more sustained energy.

Vitamins and minerals, which are vital for the proper functioning of metabolic pathways, may also be added to a nutritional bar. Examples of some of these vitamins and minerals include those vitamins and minerals listed on the U.S. Department of Agriculture's Recommended Daily Allowance (RDA) or Daily Value (DV) charts.

As is known in the art, food or nutritional bars may be substantially non-perishable and readily portable for rapid consumption. Also available are fortified food bars which advantageously provide a portion of the daily requirement of minerals and vitamins, in order to help meet nutritional needs. These fortified bars may also comprise carbohydrates, proteins, and fats. Food or nutritional bars are generally prepared by blending a mixture of ingredients together (often with a binder). The mixture is then generally molded into a size suitable for quick consumption. In the case of non-cooked food bars, ingredients are selected such that baking or cooking of the ingredients is not required.

The following are examples of nutritional bars described in the art. U.S. Pat. No. 6,676,982 describes a nutritional food bar for sustained energy. U.S. Pat. No. 4,055,669 teaches a high protein breakfast food bar using crushed dry cereal. U.S. Pat. No. 4,451,488 teaches a granola food bar which combines the textural ingredients with a polyhydric alcohol binder. U.S. Pat. Nos. 4,543,262, 4,832,971, and 4,859,475 teach fortified food bars having high protein and low or no lactose wherein a confectioner's coating is distributed uniformly throughout the core. U.S. Pat. No. 4,871,557 teaches a granola food bar having high dietary fiber in the form of compressed flakes. U.S. Pat. No. 5,612,074 teaches a fortified food bar having dietary fiber and non-animal based protein. All references cited in the present specification are incorporated by reference.

Among the components in a nutritional bar, consumers may be especially concerned with protein and calcium content. Unfortunately, higher protein and calcium content in a food bar often cause hardness of the bar over time. Therefore, described hereinbelow are methods and compositions for repositioning micronutrients, especially calcium, in a food bar to reduce hardness and, thus, to increase shelf life.

### SUMMARY OF THE INVENTION

Broadly, the present invention relates to methods and compositions for repositioning calcium and/or other micronutrients in food products, such as a nutritional bars, to minimize hardness and extend shelf-life. The methods and compositions of the present invention include applying a layer of a calcium and/or other micronutrient fortified matrix to a food bar core. The matrix may be a low moisture (generally less than about 20 percent moisture, and preferably less than about 15 percent moisture) layer or coating having calcium, or other micronutrient, solubilized therein. Preferably, the matrix is a low moisture confectionary layer or coating selected from the group consisting of chocolate, caramel, fudge (e.g., adding about 1 percent chocolate liquor to caramel form a chocolate caramel fudge-like composition), hard fat, cream filling, and the like; preferably the low moisture confectionary composition is chocolate or caramel. The resultant food product advantageously contains a substantial amount of essential micronutrients without adversely effecting organolpetic qualities such as texture.

For example, in one embodiment, the invention is a fortified confectionary product comprising: (a) an amount of at least one micronutrient; (b) a core having less than 50 percent of the amount of at least one micronutrient; and (c) at least one layer of a low moisture confectionary composition containing at least 50 percent of the amount of at least one micronutrient. Preferably, the core has less than about 40 percent of the micronutrients and the layer has more than about 60 percent of the micronutrients. More preferably, the core has less than about 20 percent of the micronutrients and the layer has more than about 80 percent of the micronutrients. Preferably, the micronutrient is, or one of the micronutrients is, calcium or magnesium. Even more preferably, the core contains less than about 5 percent of calcium or magnesium, if present and the layer has more than about 95 percent of calcium and magnesium, if present. Preferably, the fortified confectionary product contains at least about 10 percent of the DV for calcium and/or magnesium, more preferably at least about 20 percent for calcium and/or magnesium, even more preferably at least about 50 percent for calcium and/or magnesium per single serving size (typically, for a nutritional bar, about 35 to about 50 g).

In a preferred embodiment, the fortified confectionary product is a nutritional bar; other food products are contemplated by the inventors. In another preferred embodiment, the micronutrient added to the confectionary product is calcium or a calcium complex. In another embodiment, the micronutrient is a vitamin and/or mineral premix (especially one containing calcium and/or a calcium complex). The micronutrient may be mixtures of such components (e.g., a calcium containing compound and a vitamin and/or mineral premix). The layer containing the micronutrient (e.g., calcium, calcium complex, vitamin and/or mineral premix, or the like, and mixtures thereof) preferably is a low moisture confectionary composition; even more preferably, it is a chocolate or caramel composition which is applied to the confectionary product as a layer, coating, or discrete particles. In a preferred embodiment, the micronutrient content is equal to at least 0.1 percent of the confectionary product. In yet another preferred embodiment, the at least one layer containing a micronutrient is dispersed within the confectionary product by covering (or coating) the confectionary product, inserting the layer in or through the confectionary product, or providing a plurality of micronutrient containing particles in the confectionary product such that the micronutrient(s) do not adversely effect texture of the confectionary product; combinations of these dispersion methods can also be used if desired.

In another embodiment of the present invention, a fortified confectionary product prepared by the following method is described: (a) blending a mixture of ingredients together to form a core; (b) preparing a low moisture confectionary composition; (c) mixing at least one micronutrient into the low moisture confectionary composition to provide a fortified confectionary composition; (d) applying at least one layer of the fortified confectionary composition to the core; and (e) molding the core having at least one layer of the fortified confectionary composition to form the fortified confectionary product.

In a preferred embodiment, the fortified confectionary composition or layer matrix of the fortified confectionary product produced by way of the aforementioned method has a concentration of at least about 0.5 percent, and preferably about 1 to about 3 percent, of the at least one micronutrient. In another embodiment, the confectionary product is a nutritional bar containing calcium in the form of elemental calcium, calcium compounds, or calcium complexes; preferably the calcium is in the form of calcium compounds (i.e., calcium cations). In another preferred embodiment, the layer applied to the core is a chocolate or caramel layer, a chocolate or caramel coating, or a plurality of chocolate or caramel particles containing at least one micronutrient. In yet another embodiment, the amount of micronutrient contained in the confectionary product is equal to at least about 0.1 percent of the confectionary product. In a preferred embodiment, the at least one layer containing a micronutrient is dispersed within the confectionary product by covering (or coating) the confectionary product, inserting the layer in or through the confectionary product, or providing a plurality of micronutrient containing particles in the confectionary product such that the micronutrient(s) do not adversely effect texture of the confectionary product; combinations of these dispersion methods can also be used if desired.

### DETAILED DESCRIPTION

This invention relates generally to methods and compositions for the repositioning of a micronutrient in a food product, especially confectionary type food products such as nutritional bars. In a preferred embodiment, a mineral, such as calcium and/or magnesium, is distributed into a matrix comprising a low-moisture confectionary layer and/or a low-moisture confectionary coating of a food product. Preferably, calcium and/or magnesium would distributed almost exclusively, and preferably exclusively, in the low moisture confectionary layer and/or the low moisture confectionary coating. Other examples of micronutrients that may be distributed into the low-moisture confectionary layer or coating include vitamin A, vitamin C, vitamin E, vitamin D, thiamin, riboflavin, niacin, vitamin B6, folate, vitamin B12, biotin, pantothenic acid, iron, phosphorus, iodine, zinc, selenium, copper, manganese, chromium, and molybdenum. Additionally, vitamin and/or mineral premixes may be incorporated into the low-moisture confectionary layer or coating. Up to about 50 percent of these vitamins and minerals (but preferably not calcium and/or magnesium) may be distributed in the core if desired. The vitamin and/or mineral premixes for use with the present invention may include any combination of vitamins and/or minerals. Examples of such vitamins and minerals are listed hereinabove. The invention is particularly useful for minimizing hardness and extending the shelf-life of a resulting food product containing calcium or a calcium complex. Preferably the minerals are in the form of cations or complexes to increase their bioavailability.

Certain nutritional bars (e.g., BALANCE® Bars) are low moisture, high protein product which may contain significant amounts of calcium. High levels of protein may lead to adverse organoleptic properties in the food bar such as undue hardness over its expected shelf life. Although not wishing to be limited by theory, it is believed that this change is due to slow hydration of the protein by the limited water present in such nutritional bars. Thus, the hardness of the bar may increase as the the protein matrix in the food bar becomes hydrated. Again not wishing to be limited by theory, it is believed that increased amounts of calcium and/or other minerals in the core tends to worsen the bar hardness problem, often to unacceptable levels through the mineral cations interactions with the proteins, thereby allowing additional moisture update by the proteins. Experimental results indicate that the presence of calcium within the bar core is a major contributor to hardness over time.

In one especially preferred embodiment, at least about 0.5 percent (and preferably about 1 to about 3.0 percent) calcium or calcium complex (e.g., tricalcium phosphate) is added to a chocolate or caramel layer and/or chocolate or caramel coating. In other embodiments the tricalcium phosphate may be added to other types of matrixes such as fudge, hard fat, cream filling, and the like. In any case, the matrix containing a micronutrient (e.g., mineral), such as, for example, calcium or calcium complex, is added as a layer or coating to a nutritional bar. The preferred matrix for containing calcium is a chocolate or caramel coating and/or chocolate or caramel layer. By positioning the calcium, or other micronutrient, in a chocolate or caramel coating and/or chocolate or caramel layer, the ability of the calcium to complex with the protein matrix in the bar core is minimized, thus, resulting in reduced bar hardness and increased shelf-life. In a preferred embodiment, the chocolate or caramel layer and/or chocolate or caramel coating contain at least 50 percent (i.e., 50 to 100 percent) of the total amount of calcium (or calcium complex) contained in the confectionary product. In another embodiment, the chocolate or caramel and/or chocolate or caramel coating contain at least 50 percent (i.e., 50 to 100 percent) of the total amount of vitamin and/or mineral premix contained in the confectionary product. In a preferred embodiment, the core of the confectionary product contains less than 50 percent (i.e., 0 to 50 percent) of the total amount of calcium (or calcium complex) contained in the confectionary product. In another embodiment, the core of the confectionary product contains less than 50 percent (i.e., 0 to 50 percent) of the total amount of vitamin and/or mineral premix contained in the confectionary product.

The fortified compositions prepared by the present methods are ideally suited for use in snack items such as nutritional bars and other confectionary type products. However the compositions and methods described herein may also be used in cereals, baked products, candies, cookies, cereal bars, and the like. Such confectionary products are generally prepared by combining the calcium fortified matrixes prepared by the methods described herein with the confectionary product. The confectionary products of the present invention may also include sweeteners and other desired ingredients including, for example, flavors (e.g., cocoa, vanilla, chocolate, milk, and the like), additional nutritional additives (e.g., vitamins, minerals, antioxidants, and the like), fruit, colorants, processing aids (e.g., gums, emulsifiers, and the like), edible acids, and the like). Generally, optional ingredients such as flavors, nutritional additives, colorants, processing aids and the like are present at 0 to about 5 percent.

Generally, the confectionery products of this invention contain about 0.1 to about 5 percent calcium, or calcium complex, and more preferably about 0.1 to 2 percent. In another embodiment, the matrix (e.g., chocolate or caramel layer or chocolate or caramel coating) has a concentration of micronutrient between about 0.1 and about 5 percent, and more preferably between about 0.5 and about 3 percent. Protein content in the confectionary products of this invention may contain about 0.5 to about 50 percent of protein, and more preferably about 10 to about 35 percent. Especially preferred confectionary products include nutritional bars comprising a core and at least one calcium fortified layer or coating. For the purposes of this invention, a “core” is intended to mean the center of the bar. For purposes of this invention, a “layer” is intended to mean a discrete layer either covering a product or extending through a product or discrete particles or bits within a product. Thus, for purposes of this invention, a layer could include a coating covering or enrobing a nutritional bar, a discrete layer through or within a nutritional bar, and/or particles or bits within a nutritional bar. The coatings or layers can be continuous or non-continuous. Preferably the calcium or calcium complex is contained within such layers (preferably chocolate or caramel coating or chocolate or caramel layers or particles) in order to offset the tendency of the calcium, when placed in the bar core (i.e., center) to adversely affect the texture of the nutritional bar. Calcium and/or calcium complexes when placed in the core of nutritional bars (especially when present in high concentrations) tends, over time, to adversely effect the organoleptic properties, especially the texture (i.e., becoming too firm or hard) of the nutritional bar and, thereby, limiting the shelf life. By incorporating the micronutrients (e.g., calcium and/or calcium complex) within the low moisture confectionary coating and/or components, this problem is significantly reduced and/or eliminated. Thus, nutritional bars containing calcium (or other micronutrients) in the low moisture confectionary coating and/or low moisture confectionary layers have shelf lives on the order about 9 months or even longer at ambient temperatures. Generally, a similar nutritional bar having calcium distributed throughout the core would have a shelf life of less than 9 months (e.g., generally about 4 to about 8 months).

The calcium fortified low moisture confectionary coatings and/or low moisture confectionary layers of this invention have good meltability, flowability, and organoleptic properties. Although such coatings and layers are ideally suited for use in confectionary products such as nutritional bars, they may also be used in other confectionary products such as candy, candy bars, icing, cookies, ice cream, other frozen dairy products, and the like.

The confectionery products of this invention may contain about 0.5 to about 75 percent sweetener, and preferably about 10 to about 50 percent sweeteners. Sweeteners that can be used include both natural and artificial sweeteners. Examples of such sweeteners include natural sugars such as sucrose, fructose, glucose, maltose, high fructose corn syrup, and lactose and artificial sweetening agents such as saccharin, aspartame, acesulfame potassium, and sucralose. Of course, others sweeteners normally used in food processing can be used if desired. Other ingredients normally used in confectionary type products may also be included in the confectionary products of this invention.

A better understanding of the present embodiment and of its many advantages may be clarified with the following examples, given by way of illustration. Unless noted otherwise, all percentages are by weight.

### EXAMPLES

Basic Composition For Core. A nutritional bar (50 g), available commercially as BALANCE® GOLD™ (flavor caramel nut blast), contained about 210 calories, about 7 g total fat, about 4 g saturated fat, no cholesterol, about 110 mg sodium, about 115 g potassium, about 22 g total carbohydrate, less than about 1 g dietary fiber, about 13 g sugar, and about 15 g total protein (soy and milk protein). This composition was used as the core of the examples described below.

### Example 1

A nutritional bar having a similar composition as the BALANCE® GOLD™ bar described above was prepared with a caramel coating layer fortified with calcium. The caramel coating layer (about 12 g and about 3 to about 6 mm thick) contained approximately 0.15 g of tricalcium phosphate; the resulting coated nutritional bar contained about 0.75 percent calcium. The caramel was prepared according to a standard caramel recipe containing corn syrup, sugar, water, fat, protein, flavor, and lecithin and contained about 4 percent protein. Generally, the caramel may be prepared with up to about 20 percent protein; preferably, however, the caramel contains about 3 to about 5 percent protein. The tricalcium phosphate was metered into warmed caramel with agitation. A caramel layer was applied to the nutritional bar by forming a slab of caramel on a chilled roller and positioning the carmel layer on top of the core using, for example, a Sollich triple-layer bar line. The core with its caramel layer could, if desired, be enrobed with a compound coating using, for example, a Sollich commercial confectionery enrober.]

A control nutritional bar was prepared by blending an equivalent amount of tricalcium phosphate into the core of a similar nutritional bar.

The inventive nutritional bar (i.e., having a calcium fortified caramel layer) has similar organoleptic properties as compared to the control (i.e., having a calcium fortified core) as prepared. The control bar, however, exhibited undesirable hardness after storage for about 6 months at ambient temperatures. The inventive bar did not exhibit such hardness after a storage time of about 12 months under the same conditions.

### Example 2

A nutritional bar was prepared with a calcium fortified chocolate coating containing about 1.6 percent tricalcium phosphate; the resulting nutritional bar contained about 0.3 to about 0.4 percent calcium. A commercial chocolate composition (containing sugar, modified palm kernel oil, protein, cocoa powder, lecithin, and flavor) was melted in a jacketed container heated with circulating hot water (about 75° C.). The tricalcium phosphate was added the melted chocolate composition and dispersed therein with mixing for about 30 minutes to provide a slurry wherein the tricalcium phosphate particles were completely enrobed by the chocolate composition. The resulting mixture was then allowed to cool to or near ambient temperature; the resulting viscious chocolate mixtures was poured onto a flat surface and allowed to solidify. Approximately 48 hours later, the calcium containing chocolate composition was remelted and then used to enrobe a nutritional bar core (same as in Example 1). Similar results were obtained as in Example 1.

### Example 3

A nutritional bar was prepared with a caramel layer fortified with calcium, magnesium, and a vitamin/mineral premix (containing 23 vitamins and minerals). The fortified caramel mixture contained 96.25 percent caramel, 0.61 percent tricalcium phosphate, 1.00 percent magnesium oxide, and 2.14 percent of the vitamin/mineral premix. The caramel was prepared according to a standard caramel recipe containing corn syrup, water, fat, protein, flavor, and lecithin. The calcium, magnesium, and 75 percent of the vitamin/mineral premix was added to the caramel in a steam jacketed kettle at a temperature of about 45° C. The remainder of the vitamin/mineral premix was included in the nutritional bar core. The fortified caramel mix was applied to the nutritional bar core layer using a Sollich Compression Roller Bar Line. Similar results were obtained as in Examples 1 and 2.

1. A fortified confectionary product comprising:
(a) an amount of at least one micronutrient;
(b) a core having less than about 50 percent of the amount of the at least one micronutrient; and
(c) at least one layer of a low moisture confectionary composition containing at least about 50 percent of the amount of the at least one micronutrient,
wherein the at least one micronutrient does not adversely effect texture of the confectionary product.

2. The confectionary product of claim 1, wherein the low moisture confectionary composition is selected from the group consisting of chocolate, caramel, fudge, hard fat, and cream filling.

3. The confectionary product of claim 2, wherein the low moisture confectionary composition is selected from the group consisting of chocolate and caramel.

4. The confectionary product of claim 3, wherein the confectionary product is a nutritional bar.

5. The confectionary product of claim 3, wherein the at least one micronutrient includes calcium and wherein essentially all the calcium is contained in the at least one layer.

6. The confectionary product of claim 1, wherein the low moisture confectionary composition is caramel.

7. The confectionary product of claim 2, wherein the amount of the at least one micronutrient is equal to at least about 0.1 percent of the confectionary product.

8. The confectionary product of claim 1, wherein the at least one layer is (1) a continuous or non-continuous coating on the food product, (2) a continuous or non-continuous layer within the fortified food product, or (3) a plurality of particles within or on the food product.

9. The confectionary product of claim 3, wherein the at least one layer is (1) a continuous or non-continuous coating on the food product, (2) a continuous or non-continuous layer within the fortified food product, or (3) a plurality of particles within or on the food product.

10. The confectionary product of claim 1, wherein the confectionary product is prepared by a method comprising:
(a) blending a mixture of ingredients together to form the core;
(b) preparing the low moisture confectionary composition;
(c) mixing at least one micronutrient into the low moisture confectionary composition to form the at least one layer;
(d) combining the core and the at least one layer to form the confectionary product.

11. The confectionary product of claim 3, wherein the confectionary product is prepared by a method comprising:
(a) preparing a mixture of ingredients to form the core;
(b) preparing the low moisture confectionary composition;
(c) mixing at least one micronutrient into the low moisture confectionary composition to form the at least one layer;
(d) combining the core and the at least one layer to form the confectionary product.

12. The confectionary product of claim 11, wherein the at least one layer contains about 0.5 to about 3 percent of the at least one micronutrient.

13. The confectionary product of claim 12, wherein the confectionary product is a nutritional bar.

14. The confectionary product of claim 13, wherein the at least one micronutrient includes calcium.

15. The confectionary product of claim 14, wherein a single serving of the confectionary product provides at least about 50 percent of the DV of calcium.

16. A fortified food product comprising:
(a) an amount of at least one micronutrient;
(b) a core; and
(c) at least one layer containing the at least one micronutrient,
wherein the at least one layer is selected from the group consisting of chocolate, caramel, fudge, hard fat, and cream filling and wherein the organoleptic properties of the fortified food product are enhanced throughout its shelf life as compared to a similar food product wherein the at least one micronutrient is distributed throughout the core.

17. The fortified food product of claim 16, wherein the fortified food product is a nutritional bar, wherein the at least one micronutrient includes calcium, and wherein essentially all the calcium is contained in the at least one layer.

18. The fortified food product of claim 16, wherein the at least one layer is (1) a continuous or non-continuous coating on the food product, (2) a continuous or non-continuous layer within the fortified food product, or (3) a plurality of particles within or on the food product.

19. The fortified food product of claim 17, wherein the at least one layer is (1) a continuous or non-continuous coating on the food product, (2) a continuous or non-continuous layer within the fortified food product, or (3) a plurality of particles within or on the food product.

20. The fortified food product of claim 18, wherein a single serving of the fortified food product provides at least about 50 percent of the DV of calcium.

21. The fortified food product of claim 19, wherein a single serving of the fortified food product provides at least about 50 percent of the DV of calcium.

22. The fortified food product of claim 20, wherein the at least one layer is selected from the group consisting of chocolate and caramel.

23. The fortified food product of claim 21, wherein the at least one layer is selected from the group consisting of chocolate and caramel.
